(19) United States
(12) Patent Application Publication
(10) Pub. No.: US 2010/0092237 A1
(43) Pub. Date: Apr. 15, 2010

(54) SHAFT-GEAR CONNECTION

(75) Inventor: Wilhelm Hardtle, Markdorf (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/447,697

(22) PCT Filed: Oct. 12, 2007
(86) PCT No.: PCT/EP2007/060883

§ 371 Date: Apr. 29, 2009

(30) Foreign Application Priority Data
Nov. 4, 2006 (DE) 10 2006 052 104.8

(51) Int. Cl. F16B 4/00; B23P 11/02; B23K 20/12

(52) U.S. Cl. 403/273; 29/446; 228/112.1

(57) ABSTRACT

A shaft-gear connection and method for producing the connection which includes a shaft (2) and a shrunk-on gear (4). The gear (4) has a first axial section (5) attached to the shaft (2) by a first shrink-fit (8) and a second axial section (6) attached to the shaft (2) by a second shrink-fit (9). The second shrink-fit (9) allows greater torques to be transmitted from the gear (4) to the shaft (2) than the first shrink-fit (8). An intermediate axial section (7) of the gear (4), attached to the shaft (2) by a third shrink-fit (10), is located between the first and second axial sections (5, 6). The torque transmitted from the gear (4) to the shaft (2) by the third shrink-fit (10) is greater than the first shrink-fit (8) but smaller than the second shrink-fit (9). The connection allows greater torque to be transmitted without increasing the risk of damaging the external gearing.

This application is a National Stage completion of PCT/EP2007/060883 filed Oct. 12, 2007, which claims priority from German patent application serial no. 10 2006 052 104.8 filed Nov. 4, 2006.

### FIELD OF THE INVENTION

The invention relates to a shaft-gear connection comprising a shaft and a shrunk-on gear. The shrunk-on gear has a first axial section that is attached to the shaft by means of a first shrink-fit and a second axial section that is attached to the shaft by means of a second shrink-fit. The second shrink-fit allows greater torques to be transmitted from the gear to the shaft than with the first shrink-fit. The invention also relates to a method for producing such a gear-shaft connection.

### BACKGROUND OF THE INVENTION

Shafts that transmit torques and have gears arranged on the shafts are very common in transmission manufacturing. There are a large number of options for attaching these gears to the shaft, whereby the types of connections are subdivided into elementary shaft-hub joints and combined shaft-hub joints.

The elementary shaft-hub joints comprise form-locking connections, such as the spline shaft connection, the kerf tooth connection, the involute profile connection, the polygon profile connection, the fitted key connection and the pin connection; the force-fitting connections, such as the crimp connection and the shrink-fit, the keyed joint, the clamping ring connection, the jockey pulley connection and the star washer connection; and the materially engaging connections, such as the welded connection, the soldered connection, and the glued connection.

The combined shaft-hub-joint connections include non materially-engaging connections, such as the pressure knurl connection and the pressure point closure connection; non-materially engaging/materially-engaging connections, such as the pressure adhesion connection, the pressure pressure-soldering connection and the pressure welding connection; and materially engaging connections, such as the soldering-welding connections, for example.

The types of known connections described above are characterized by the disadvantage that movement of the components or, as the case may be, the gears on the shaft is not prevented. Despite optimized design, microscopic movements do occur, for example, due to load peaks. This kind of movement of the gears on the shafts must be avoided at all costs, particularly in transmissions in which exact alignment of gear teeth of different gears in relation to each other plays a decisive role. This is particularly the case in transmissions with load distribution between two or more countershafts; here, absolute placement precision is required throughout the lifetime of the transmission.

In order to resolve the problem cited above, DE 196 20 330 A1 proposes a shaft-hub-joint connection for a component on a shaft in which, on the one hand, the component is shrunk-fit to the shaft and, on the other, in which it is also held in place by means of a form-locking connection, in order to avoid movement. More precisely, the cited document proposes to attach a gear to the shaft by means of a shrink-fit and to provide a pin-shaped element that extends, on the one hand, into the shaft and, on the other, into the gear, to obtain a form-locking connection.

An additional permanent shaft-hub connection is known from DE 103 19 629 A1 in which the gear is attached by means of a shrink-fit to the shaft, i.e. by means of shrink-fitting. The cited document also proposes that immediately adjacent gears partially overlay each other, in which case the adjacent regions of the gears are also connected by means of a shrink-fit.

The shaft-hub connections known from the previous documents comprise gears with a first axial section that has external cogging and a second axial section that has no gear teeth. Shrink-fitting these gears to the shaft causes shrinkage stress that is superimposed on the stress on the bases of the gear teeth, so that a multi-axial stress-state arises in the first section. In the worst possible case, this multi-axial stress-state can lead to a break in one or more of the gear teeth of the cogging. For this reason, practice has been modified so that in the first axial section, which is provided with the cogging, a weaker shrink-fit is produced than is produced in the second axial section, so that there is less shrinkage stress in the first axial section. In this way, through a reduction in the shrinkage stress in the first axial section, damage to the cogging from superposition of stress can be avoided. This measure has the disadvantage, however, of reducing the maximum torque that can be transmitted from the gear to the shaft.

### SUMMARY OF THE INVENTION

The basic object of this invention is therefore to create a shaft-gear connection with a shaft and a shrunk-fit gear that enables the transmission of a great torque from the gear to the shaft, while at the same time effectively preventing damage to the gear teeth. A further object of the invention is also to propose a method of manufacturing this kind of advantageous shaft-gear connection.

The inventive shaft-gear connection features a shaft and a gear that is shrunk-fit to the shaft. The gear is comprised of a first axial section that is attached to the shaft by means of a first shrink-fit and a second axial section in which the second axial section is attached to the shaft by means of a second shrink-fit. The second shrink-fit is configured here in such a way that greater torques can be transmitted with it from the gear to the shaft or in the opposite direction than can be transmitted with the first shrink-fit. Inventively, an axial intermediate section is provided between the first axial section and the second axial section, the intermediate section being attached by means of a third shrink-fit to the shaft. The third shrink-fit allows greater torques to be transmitted from the gear to the shaft than the first shrink-fit and smaller torques than the second shrink-fit. This characteristic relates to the maximum torques which can be transmitted in each case. Different transmissions of torques can be achieved here, for example, by an appropriate selection of the surface pressure in the first axial section, in the second axial section, and in the axial intermediate section during shrink-fitting.

A continuous transfer of strain can be achieved between the first axial section and the second axial section by means of the axial intermediate section and the inventive selection of the third shrink-fit. In turn, this continuous transfer of strain makes it possible for greater torques which are induced, for example, via a set of gear teeth in the first axial section to be transmitted from the gear to the shaft of the shaft-gear connection.

In a preferred embodiment of the inventive shaft-gear connection, the third shrink-fit is configured in such a way that the magnitude of the torque transmitted from the gear to the shaft in the direction of the second axial section is increased in the axial intermediate section. An increase of this kind in the transmittable torque can take place incrementally in the direction of the second axial section. The example embodiment explained below, however, would be particularly advantageous.

In this particularly preferred example embodiment of the inventive shaft-gear connection, the third shrink-fit is designed in such a way that the magnitude of the torque, which can be transmitted from the gear to the shaft in the direction of the second axial section, is continually, or, as the case may be, constantly increased in the axial intermediate section. By designing the transfer of stress between the first axial section and the second axial section to be continuous, the magnitude of the torque that can be transmitted from the gear to the shaft can be additionally increased.

According to an advantageous embodiment of the inventive shaft-gear connection, the first axial section is provided with cogging, preferably external teeth, whereby the second axial section has no gear teeth.

In a particularly advantageous embodiment of the inventive shaft-gear connection, the sets of gear teeth have a plurality of teeth, whereby the bases of the teeth are ground. For example, the right and left flanks of the teeth in the region of the tooth bases can be ground. The ground bases of the teeth can tolerate greater stress than non-ground tooth bases. In this way, it is possible to make the first shrink-fit in the first axial section stronger, because the shrink stress in the first axial section can be greater without resulting in the superposition of stress resulting in damage to the gear teeth. It is possible, however, to transmit a greater torque, via the gear, to the shaft with a stronger first shrink-fit in the first axial section.

According to an additional advantageous embodiment of the inventive shaft-gear connection, the bases of the teeth are ground using a blasting method. The bases of the teeth are advantageously ground using sand and/or glass-bead blasting media. Using this method, the bases of the gear teeth have proven particularly robust.

In order to particularly effectively avoid the gear teeth breaking in the region of the tooth bases, the bases of the gear teeth are ground with the help of at least two successive blasting methods in a particularly preferred embodiment of the inventive shaft-gear connection. This is also referred to as a so-called duo-blasting of the tooth base. The successive blasting methods are preferably two different blasting methods, such as sand-blasting and glass-bead blasting. The more stable the bases of the gear teeth are, the stronger the first shrink-fit in the first axial section can be, and the stronger the torque that can be transmitted from the gear to the shaft.

In another preferred embodiment of the inventive shaft-gear connection, at least one additional gear that is not shrunk-fit is attached to the shaft. The additional gear can, for example, be attached with the aid of a feather key. The bases of the gear teeth of the shrunk-fit gear are then designed wider as compared to the bases of the gear teeth of the non shrunk-fit gear. This also increases the stability of the gear teeth of the shrunk-fit gear which makes it possible to have a stronger first shrink-fit in the first axial section which in turn makes it possible to transmit especially great torques from the gear to the shaft.

According to another advantageous embodiment of the inventive shaft-gear connection, the height of the gear teeth is diminished in the direction of the second axial section. Preferably, the height of the teeth in the direction of the second axial section is continuously diminished. For example, in the region of the axial intermediate section, the teeth can extend, continuously diminishing in height, until they merge into the second axial section.

According to an additional advantageous embodiment of the inventive shaft-gear connection, the gear is additionally attached to the shaft by means of a friction-weld. This friction-weld is advantageously produced by twisting the shaft in relation to the gear during or after the shrink-fitting procedure.

The inventive method of producing a shaft-gear connection comprises the process steps cited below. First, a shaft and a gear are prepared, whereby the gear has a first axial section, a second axial section, and an axial intermediate section. Then the gear is shrunk-fit to the shaft, so that a first shrink-fit is formed in the first axial section, a second shrink-fit in a second axial section, and a third shrink-fit in the axial intermediate section. The shrink-fitting is done in such a way that the third shrink-fit allows greater torques to be transmitted from the gear to the shaft than the first shrink-fit and smaller torques than the second shrink-fit. This can be accomplished, for example, by the shaft and/or the gear having different external and internal diameters in the region of the cited sections, so that in the cited sections, different surface pressures can be produced. For the advantages of this, reference is made to the previous description of the inventive shaft-gear connection.

In a preferred embodiment of the inventive method, the first axial section of the gear is provided with cogging, preferably external cogging with a plurality of gear teeth, while the second axial section has no teeth, whereby the bases of the teeth are ground. Here, fundamentally, all conventional grinding processes can be used.

In order to produce particularly stable tooth bases, however, the bases of the gear teeth in a particularly preferred embodiment of the inventive method are ground with the aid of a blasting method. This is preferably done using sand and/or glass-bead blasting.

In an additional, particularly preferred embodiment of the inventive method, the bases of the gear teeth are ground using at least two successive grinding processes, such as sand-blasting and glass-bead blasting, for example.

In order to additionally increase the maximum possible torque transmission between gear and shaft, the shaft and the gear are twisted in relation to each other during or after the shrink-fitting in an additional preferred embodiment of the inventive method, in order to produce a friction-weld between the shaft and the gear.

### BRIEF DESCRIPTION OF THE DRAWINGS

The invention will be explained in more detail below on the basis of one exemplary embodiment with reference to the associated drawings.

The following are shown:

FIG. 1A lateral view of an embodiment of the inventive shaft-gear connection in a cross-sectional presentation;

FIG. 2 A diagram illustrating the maximum transmittable torque in the axial sections, and

FIG. 3 A partial view of the gear teeth in the direction of the arrow A in FIG. 1

### DETAILED DESCRIPTION OF THE PREFERRED EMBODIMENTS

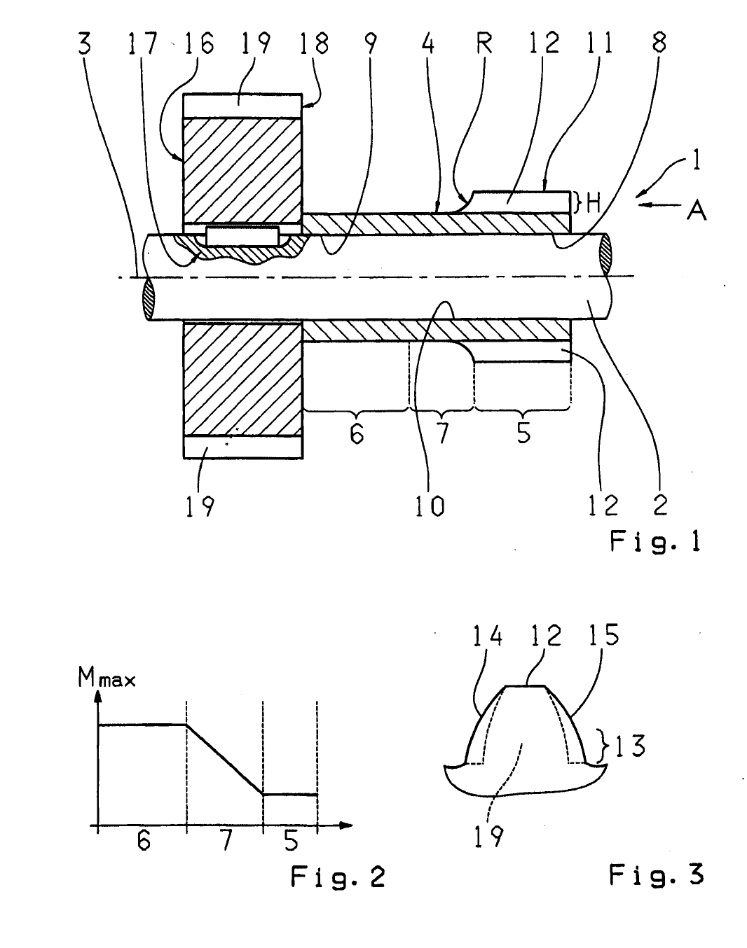

FIG. 1 presents a lateral view of an embodiment of the inventive shaft-gear connection 1. To start with, the shaft-gear connection 1 comprises a shaft 2 that is rotatable around its longitudinal axis 3. A gear 4 is shrunk-fit to the shaft 2. The gear 4 comprises a first axial section 5 and a second axial section 6, and between the first axial section 5 and the second axial section 6, an intermediate section 7 is provided. The sections referred to as 5, 7, 6 are directly attached to each other.

The first axial section 5 is attached to the shaft 2 by means of a first shrink-fit 8, while the second axial section 6 is attached to the shaft 2 by means of a second shrink-fit 9. The axial intermediate section 7 is also attached to the shaft by means of a shrink-fit, whereby this third shrink-fit is referred to in FIG. 1 with the reference sign 10.

As can be seen in FIG. 2, the second shrink-fit 9 is designed in such a way that in the second axial section 6, a greater maximum torque can be transmitted from the gear 4 to the shaft 2 than is the case with the first axial section 5. By means of the third shrink-fit 10 in the axial intermediate section 7, a greater maximum torque can be transmitted from the gear 4 to the shaft 2 than is the case with the first axial section 5, whereas the maximum torque that can be transmitted by means of the third shrink-fit 10 is smaller than the maximum torque that can be transmitted by means of the second shrink-fit 9, as can be seen in FIG. 2. Here, the third shrink-fit 10 is designed in such a way that the magnitude of the maximum torque which can be transmitted from the gear 4 to the shaft 2 in the direction of the second axial section 6 in the second axial intermediate section 7 is continuously or, as the case may be, constantly increased. In this way, there is continuous transfer of strain between the first axial section 5 and the second axial section 6.

As can be seen from FIG. 1, the first axial section 5 of the gear 4 has external teeth 11. The second axial section 6, however, has no teeth at all. The external teeth 11 are preferably designed as helical gearing and comprise a plurality of teeth 12. One of the teeth 12 is shown as an example in FIG. 3. The section of each tooth 12 facing the longitudinal axis 3 is designated as tooth base 13. The left flank 14 and the right flank 15 of the tooth 12 are, at least in the region of the tooth base 13, ground by a blasting method, preferably sand and/or glass-bead blasting. During this process, the tooth bases are ground of so-called duo-blasting, in which two successive blasting methods of different types are used, as for example blasting with sand and glass beads. In addition, the height H of the teeth 12 is diminished in an axial direction, specifically in the direction of the second axial section 6. During this process, the height H is continuously reduced, whereby the upper edge is depicted as a circular arc in the lateral view. In that way, by selecting a particularly large radius R for the circular arc, it is possible to have particularly continuous transition from the gearing to the axial intermediate section 7 of the second axial section 6. This results in a particularly good and continuous transfer of stress between the sections 5, 6, 7.

Furthermore, at least one additional gear 16, which is not shrunk-fit to the shaft 2, is attached to the shaft 2. In the present example, the gear 16 is instead connected to the shaft 2 by a feather key 17. The additional gear 16 also has external gearing 18 which is made up of a plurality of teeth 19. The bases 13 of the teeth 11 of the shrunk-fit gear 4 are designed broader as compared to the tooth bases of the gearing 18 of the gear 16 that is not shrunk-fit, as indicated in FIG. 3, in which the teeth 19 of the gearing 18 of the gear 16 are indicated by means of a dotted line.

Furthermore, the gear 4 is attached by means of a friction-weld to shaft 2. This friction-weld is produced by twisting the gear 4 during or after shrink-fitting to shaft 2 in relation to the shaft 2 around the longitudinal axis 3, whereupon a friction-weld is produced. The different strengths of the shrink-fits 8, 9, 10 can be achieved, for example, by the shaft 2 and/or the gear 4 having slightly different external or, as the case may be, internal diameters in the sections 5, 6, 7. In this way, after shrink-fitting, different surface pressures are achieved which ultimately result in different strengths of the shrink-fits and the different abilities to transmit torques.

### REFERENCE CHARACTERS

1 Shaft-gear connection
2 Shaft
3 Longitudinal axis
4 Gear
5 First axial section
6 Second axial section
7 Axial intermediate section
8 First shrink-fit
9 Second shrink-fit
10 Third shrink-fit
11 External teeth
12 Teeth
13 Tooth base
14 Left flank
15 Right flank
16 Additional gear
17 Feather key connection
18 External gearing
19 Teeth
H Height of the teeth
Mₘₐₓ Maximum transmittable torque in one section
R Radius

1-15. (canceled)

16. A shaft-gear connection comprising a shaft (2) and a shrunk-on gear (4) that has a first axial section (5), which is attached to the shaft (2) by a first shrink-fit (8), and a second axial section (6), which is attached to the shaft (2) by a second shrink-fit (9), with the second shrink-fit (9) enabling greater torque to be transmitted from the gear (4) to the shaft (2) than the first shrink-fit (8), an axial intermediate section (7) being located between the first axial section (5) and the second axial section (6) and being attached to the shaft (2) by a third shrink-fit (10), torque that is to be transmitted from the gear (4) to the shaft (2) by the third shrink-fit (10) is greater than torque transmitted by the first shrink-fit (8) but less than torque transmitted by the second shrink-fit (9).

17. The shaft-gear connection according to claim 16, wherein the third shrink-fit (10) is designed such that a magnitude of torque which is transmittable, from the gear (4) to the shaft (2) in a direction of the second axial section (6), increases in the axial intermediate section (7).

18. The shaft-gear connection according to claim 17, wherein the third shrink-fit (10) is designed such that the magnitude of torque which is transmittable, from the gear (4) to the shaft (2) in the direction of the second axial section (6), continuously increases in the axial intermediate section (7).

19. The shaft-gear connection according to claim 17, wherein the first axial section (5) has gearing (11) with external teeth, while the second axial section (6) of the gear (4) has no teeth.

20. The shaft-gear connection according to claim 19, wherein the gearing (11) comprises a plurality of gear teeth (12) with bases (13) of the gear teeth (12) which are ground.

21. The shaft-gear connection according to claim 20, wherein the bases (13) of the gear teeth (12) are ground by at least one of sand-blasting and glass-pearl blasting.

22. The shaft-gear connection according to claim 21, wherein the bases (13) of the gear teeth (12) are ground with by at least two different successive blasting methods.

23. The shaft-gear connection according to claim 20, wherein at least one additional gear (16) is attached to the shaft (2) by a different than shrink-fitting, the bases (13) of the gear teeth (12) of the gearing (11) are broader than bases of gear teeth of gearing (18) of the at least one additional gear (16).

24. The shaft-gear connection according to claim 20, wherein a height (H) of the gear teeth (12), in a direction of the second axial section (6), decreases continuously.

25. The shaft-gear connection according to claim 16, wherein the gear (4) is also attached to the shaft (2) by a friction-weld.

26. A method of producing a shaft-gear connection, the method comprising the steps of:
preparing a gear with a first axial section, a second axial section, and an axial intermediate section; and
shrink-fitting the gear to a shaft so that a first shrink-fit is achieved in the first axial section, a second shrink-fit is achieved in the second axial section, and a third shrink-fit is achieved in the axial intermediate section, and the third shrink-fit allows greater torque to be transmitted from the gear to the shaft than by the first shrink-fit, but allows transmission of smaller torques than is transmittable by the second shrink-fit.

27. The method of producing a shaft-gear connection according to claim 26, further comprising the steps of
providing the first axial section of the gear with external gearing having a plurality of gear teeth, each of which has a base that is ground, and
providing the second axial section no gearing.

28. The method of producing a shaft-gear connection according to claim 27, further comprising the step of grinding the bases of the gear teeth by at least one of sand blasting and glass-bead blasting.

29. The method of producing a shaft-gear connection according to claim 28, further comprising the step of grinding the bases of the gear teeth by two different successive blasting methods.

30. The method of producing a shaft-gear connection according to claim 26, further comprising the step of friction welding the shaft and the gear either during or after shrink-fitting by twisting the shaft and the gear with respect to one another.
